(19) United States
(12) Patent Application Publication
(10) Pub. No.: US 2024/0017431 A1
(43) Pub. Date: Jan. 18, 2024

(54) HVAC Duct Cutting Tool

(71) Applicant: DC Tool Group, LLC, Chandler, AZ (US)

(72) Inventors: Brandon Breneman, Chandler, AZ (US); Marc Faris, Chandler, AZ (US); Mark Veilleux, Georgetown (KY)

(73) Assignee: DC Tool Group, LLC, Chandler, AZ (US)

(21) Appl. No.: 17/812,799

(22) Filed: Jul. 15, 2022

(51) Int. Cl. B26B 5/00; B26B 1/04; F24F 13/02

(52) U.S. Cl. CPC B26B 5/00; B26B 1/04; F24F 13/0245

(57) ABSTRACT

A cutting tool has a base. A blade opening is formed through the base. The blade opening includes a front edge and a back edge oriented in parallel to the front edge. A plurality of interchangeable blade holders is configured to be installed into the blade opening. Each of the interchangeable blade holders includes a front flange configured to sit on the front edge of the blade opening and a back flange configured to sit on the back edge of the blade opening.

### FIELD OF THE INVENTION

The present invention relates in general to tools and, more particularly, to a cutting tool for HVAC ducting.

### BACKGROUND OF THE INVENTION

Installers of heating, ventilation, and air conditioning (HVAC) systems are turning to foam-based ducting for versatile, reliable, and cheap HVAC ducting. The foam ducting is manufactured as large sheets or panels of foam material that are cut to the shapes needed to form HVAC ducts. The cut pieces of foam are then taped or glued together into the three-dimensional (3D) shapes as needed to guide air flow in an HVAC system.

Cutting the foam panels is typically done by a set of cutting tools. A different cutting tool is utilized depending on the desired angle of the cut. The cutting tool set is not adjustable and can only be used for a fixed number of predefined cuts. Moreover, each possible cut requires an entire cutting tool to perform that individual cut. A full set of cutting tools with a reasonable number of possible cuts quickly becomes very heavy and large, commonly requiring a large carrying case. Therefore, a need exists for an improved HVAC ducting cutting tool.

### BRIEF DESCRIPTION OF THE DRAWINGS

FIGS. 1a-1e illustrate a cutting tool for HVAC ducting;

FIGS. 2a-2g illustrate interchangeable blade holders for the cutting tool;

FIGS. 3a-3d illustrate installing the blade holders onto the cutting tool;

FIG. 4 illustrates cutting a panel to size;

FIGS. 5a-5c illustrate cutting 45-degree angles to make a square duct;

FIGS. 6a and 6b illustrate cutting two 45-degree angles at once to make a 90-degree cut;

FIGS. 7a-7c illustrate two 22.5-degree cuts forming a 45-degree cut; and

FIGS. 8a-8c illustrate a shiplap cut.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention.

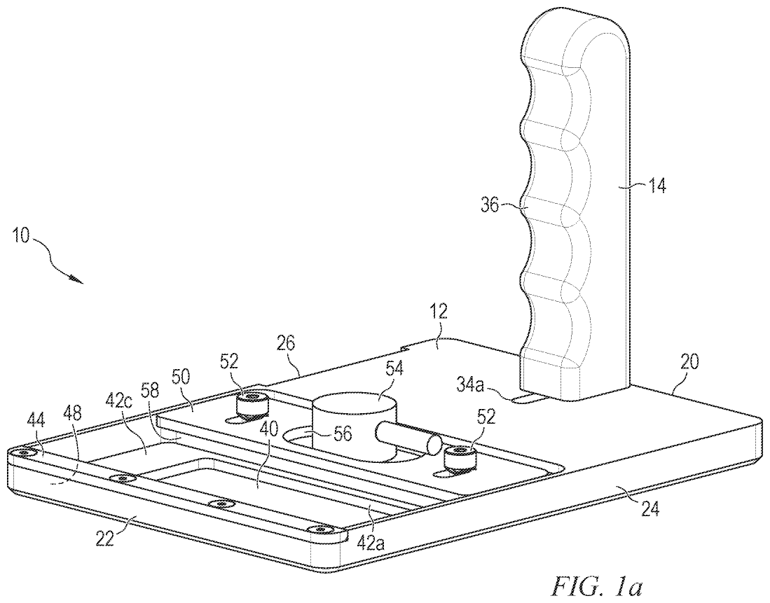

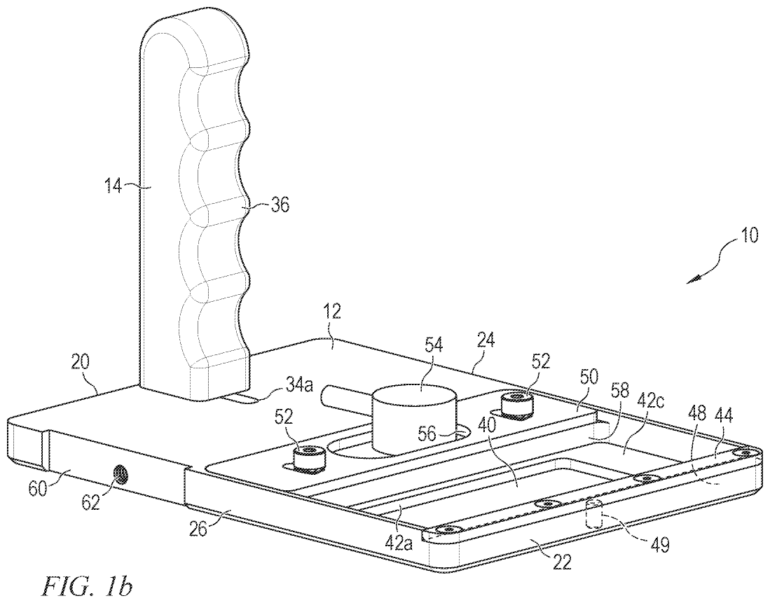

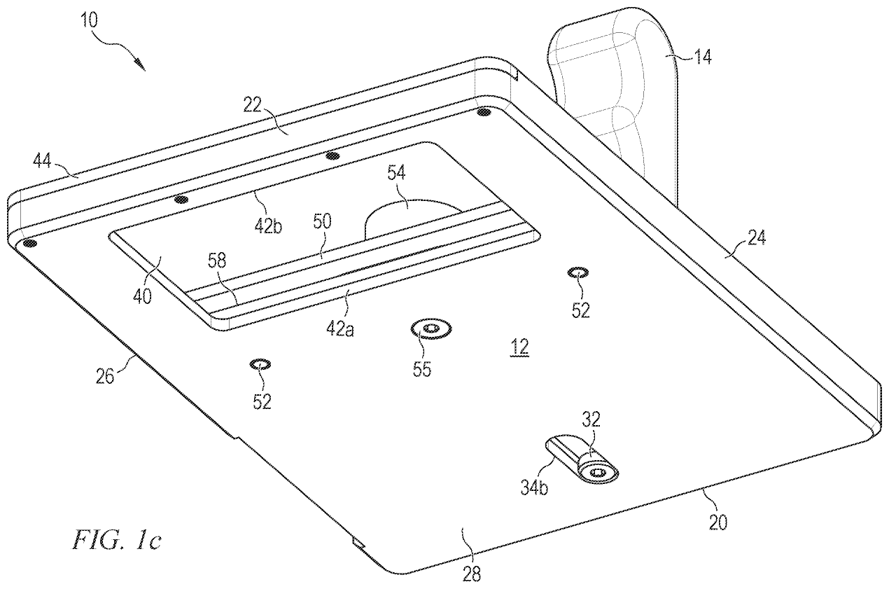

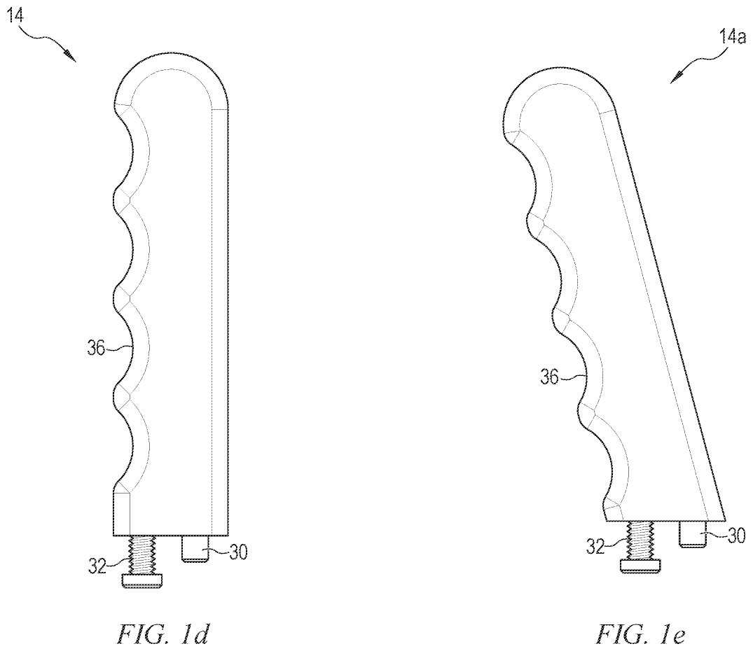

FIGS. 1a-1e illustrate a cutting tool 10 for cutting foam panels for HVAC ducting. Cutting tool 10 is also useful for cutting other materials and for other purposes. Unless otherwise indicated below, all parts of cutting tool 10 are formed from machined metal. The metal can be titanium, stainless steel, aluminum, copper, other alloys, or any other suitable material. In other embodiments, the parts of cutting tool 10 are formed by molding, 3D-printing, or another suitable process. Non-metal materials may be used, such as plastic, other polymers, wood, or any other suitable material or combination of materials.

Cutting tool 10 has a main body 12 and a handle 14. FIGS. 1a-1c illustrate three different views of cutting tool and FIGS. 1d and 1e illustrate alternative handle embodiments. Main body 12 has a flat rectangular shape with four edges 20, 22, 24, and 26 forming a rectangle. Front edge and back edge 22 are parallel to each other, and perpendicular to right edge 24 and left edge 26. Front edge 20 is referred to as the front because cutting tool 10 is designed to be pulled by handle 14 with front edge 20 leading. Front edge 20 may not literally be the front in all possible usages or orientation of cutting tool 10.

Bottom surface 28 of body 12 is shown in FIG. 1c. Bottom surface 28 is a flat surface that extends all the way from, to, and between all four edges 20, 22, 24, and 26. Bottom surface 28 is the bottom-most surface of cutting tool Being flat allows bottom surface 28 to slide smoothly along a foam panel during use of the cutting tool. Any bolts or screws extending through body 12 with their heads oriented downward are counter-sunk into bottom surface 28 so that the screws do not extend below the bottom surface and drag against a foam panel being cut.

Handle 14 can be designed into a variety of shapes and angles that are interchangeable depending on the comfort of the user or the specific angle of usage. FIGS. 1d and 1e illustrate two possible handle embodiments with differing angles with respect to the plane of body 12. Handle 14 in FIG. 1d is vertical or perpendicular relative to body 12, while handle 14a in FIG. 1e is angled toward back edge 22. A user of cutting tool 10 can interchange handles 14 and 14a, and any other included handles, based on which is more comfortable for the user or more useful in a given situation.

Handle 14 is installed onto body 12 with a peg 30 and bolt 32 on the bottom of the handle inserted into a slot 34 of the body. Slot 34 is formed completely through body 12 by two separate slots 34a and 34b formed into opposite sides of the body to meet each other. Slot 34a formed into the top of body 12 is thinner than slot 34b formed into bottom surface 28. The thinner slot 34a allows peg 30 and the shaft of bolt 32 through but is thinner than the head of bolt 32 so that the bolt can be tightened down against body 12 around slot 34a. Slot 34b is wider to fit the head of bolt 32, and deep enough to fit the height of the bolt head so that bolt 32 does not extend down below bottom surface 28 when tightened. The head of bolt 32 fits entirely within slot 34b.

Slot 34a extends further toward front edge 20 than slot 34b, so that when bolt 32 is installed as far forward as possible within slot 34b, as shown in FIG. 1c, peg 30 is at the furthest forward part of slot 34a. Having two points of contact between handle 14 and body 12, i.e., peg 30 and bolt 32, reduces the amount that the handle rotates during use. Bolt 32 can be loosened to adjust the position of handle 14 on body 12 in the forward-backward direction. Bolt 32 is illustrated as a hex bolt, but any suitable type of bolt or screw head can be used in other embodiments. Handle 14 has finger grips 36 formed in the back of the handle to reduce the likelihood of cutting tool 10 slipping out of a user's hand.

Base 12 has a blade opening 40 located toward back edge 22 from handle 14. Blades being located rearward from handle 14 allows cutting tool 10 to be pulled with the blades being dragged behind the handle, which stabilizes the cut like the rudder of a boat. Opening 40 includes a front edge 42a and back edge 42b that run in parallel. A blade holder, when installed into cutting tool 10, will sit on edges 42a and 42b with a cutting blade extending down through opening 40 under bottom surface 28. Having parallel front and back edges allows the blade holders to slide left and right within blade opening 40, thereby adjusting the position of the blade relative to handle 14. Side edges 42c are wider due to the angled blade holders that typically sit at the extremes of blade opening 40 having wider bases. In other embodiments, side edges 42c are as thin as front edge 42a and back edge 42b to allow a wider range of blade positioning.

A back brace 44 is bolted down to base 12 over back edge 42b to create a pocket 48 between the back brace and back edge. A flange of a blade holder will be inserted into pocket 48 when installing the blade holder into cutting tool 10. Back brace 44 is a separate piece bolted onto base 12 to ease manufacturing requirements, but the base can be machined or 3D-printed with pocket 48 formed in a single block of material in other embodiments. A dowel 49 or other bump or detent is disposed within pocket 48 to allow blade holders to be installed centered within opening 40. The blade holders include a recess that is placed on or around dowel 49 to center the blade holder with handle 14.

A front brace 50 is attached to base 12 with two bolts 52 extending through openings of the front brace. The openings in front brace 50 for bolts 52 are elongated front-to-back to allow the front brace to slide forward and backward. The sliding of front brace 50 is actuated by turning a cammed handle 54. Handle 54 is attached to base 12 with an off-center bolt 55 so that the position of handle 54 changes as the handle is rotated. Handle 54 is installed through opening 56 of front brace 50 that has approximately the same width front-to-back as the diameter of handle 54 so that the front-to-back position of the front brace changes as handle 54 is turned. Opening 56 is elongated laterally to allow handle 54 to shift left-to-right as it rotates around bolt 55 without pressing against front brace 50.

FIG. 1a shows handle 54 turned so that front brace 50 is slid toward the back of base 12. When front brace 50 slides back, the front brace extends over edge 42a to form a front pocket 58, similar to pocket 48 on the back side of opening 40. Having the flange of the blade holder within pockets 48 and 58 in combination keeps the blade holders from moving significantly in the vertical direction. Handle 54 is turned until front brace 50 presses the installed blade holder between the front brace and back pocket 48, which fully braces the blade holder from significant movement relative to base 12 during use.

FIG. 1B shows handle 54 turned so that front brace 50 is slid forward, thus removing the top of pocket 58 and releasing any installed blade holders from base 12 and allowing installation of blade holders. Sliding front brace 50 forward allows the blade holders to be interchanged and repositioned. Once the desired blade holders are positioned at the desired locations within opening 40, handle 54 is returned to the position of FIG. 1a to lock the blade holders in cutting tool 10.

Left edge 26 includes a recess 60 with a threaded hole 62 within the recess. A horizontal blade holder can be attached along edge 26 using threaded hole 62. The front and back edges of recess 60 keep the horizontal blade holder aligned so that a bolt of the horizontal blade holder can be screwed into threaded hole 62. In some embodiments, right edge 24 has a recess 60 and threaded hole 62 to allow a horizontal blade to be attached onto the right edge as well.

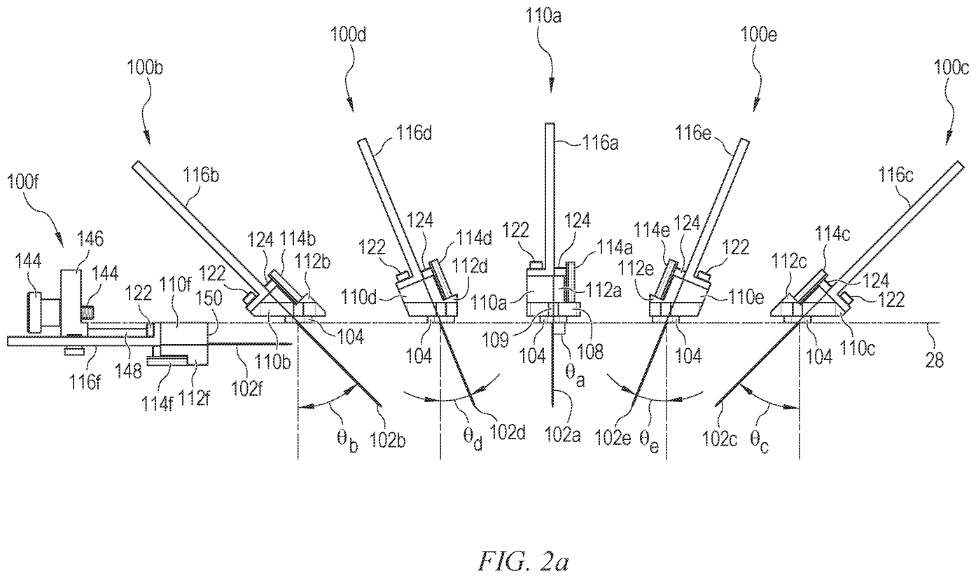

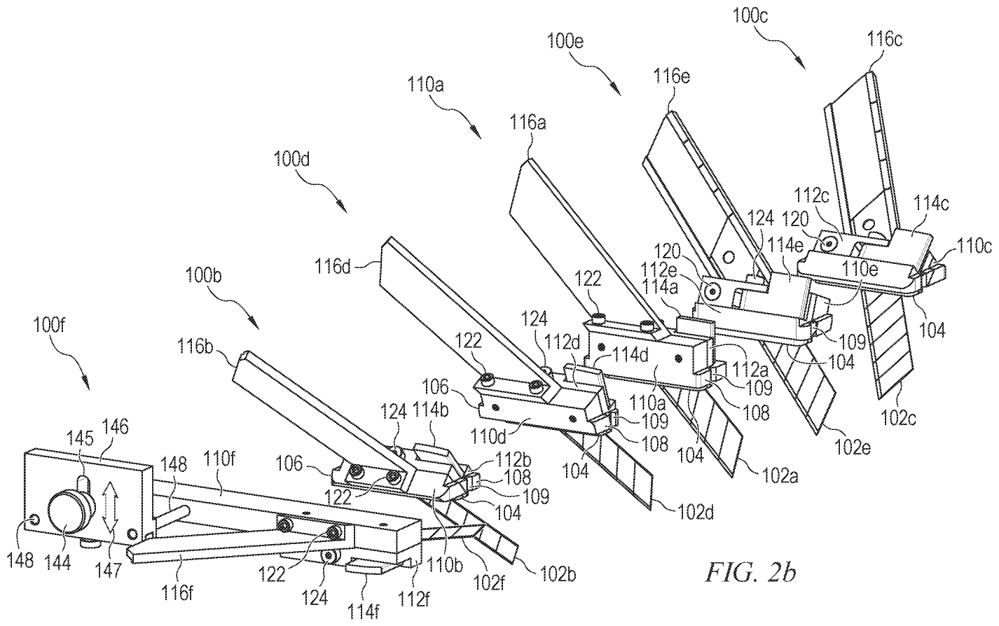

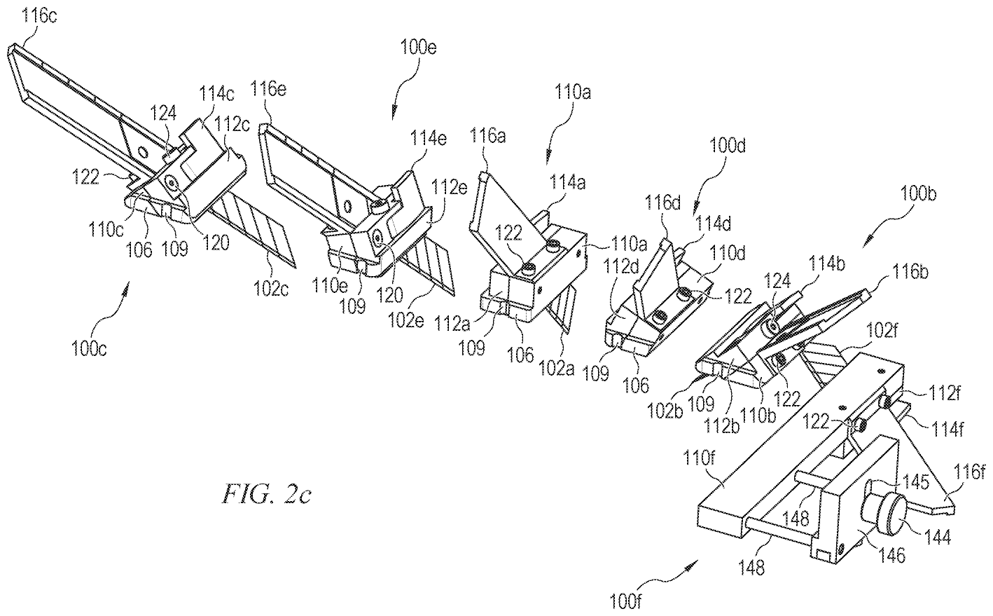

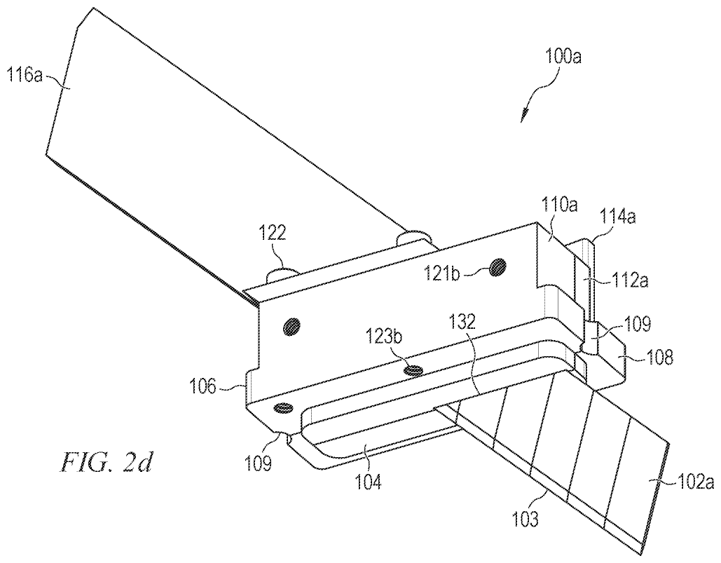

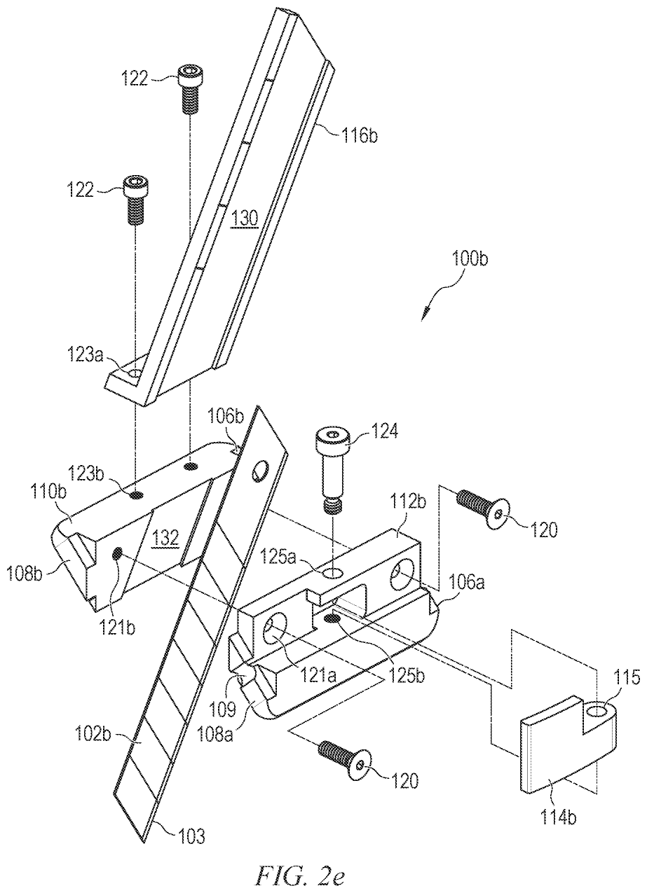

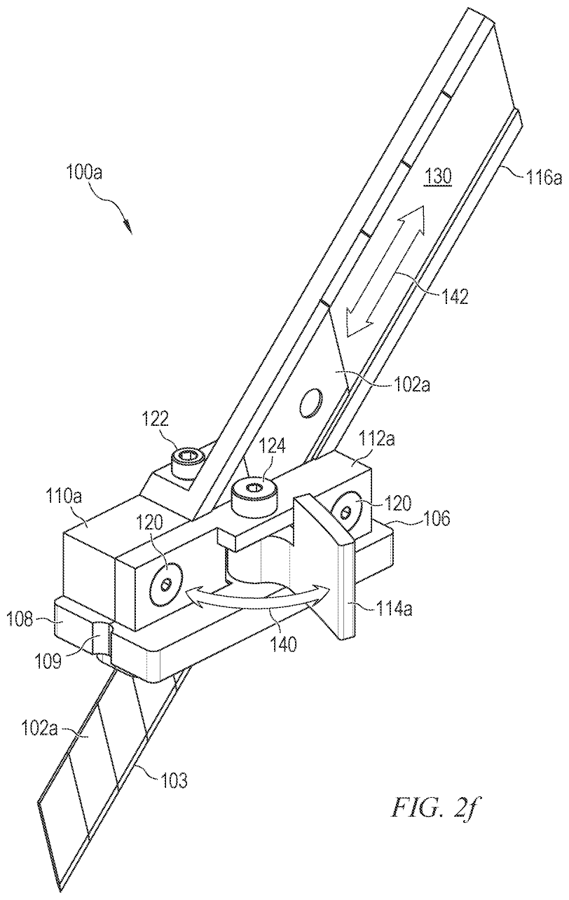

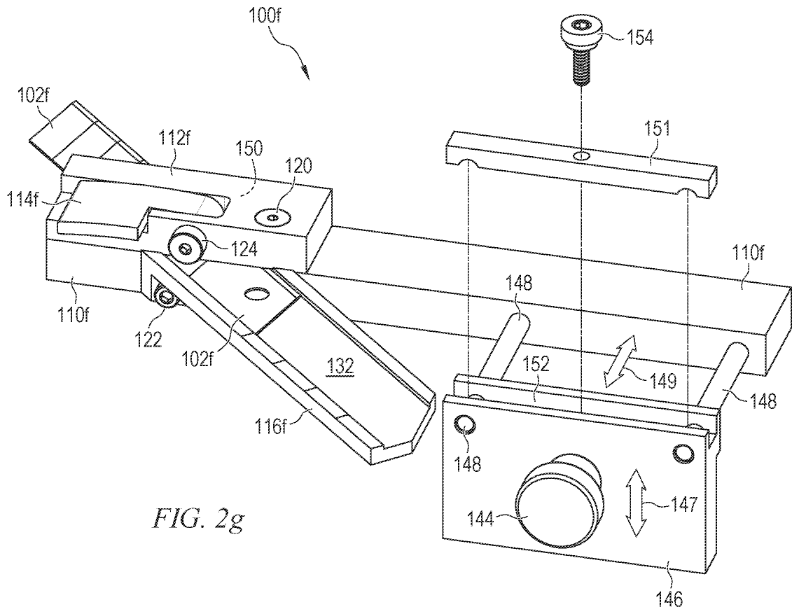

FIGS. 2a-2g illustrate blade holders 100 for use with cutting tool 10. Six blade holders 100a-100f are illustrated to provide six different cutting angles. The basic concepts for blade holders 100 can be modified to hold a blade at any desired angle. FIGS. 2a-2c show the six blades from three different angles. FIG. 2d shows the underside of blade holder 100a. FIG. 2e is an exploded view of blade holder 100b.

Blade holder 100a is designed to hold a blade 102a vertically, i.e., at a 90-degree angle θₐ relative to bottom surface 28 of cutting tool 10. Blade holder 100b is designed to hold a blade 102b at a 45-degree angle θ_{b} relative to vertical. Blade holder 100c is designed to hold a blade 102c at a 45-degree angle θ_{c} relative to vertical, but in the opposite direction of blade 102b. Blade holder 100d is designed to hold a blade 102d at a 22.5-degree angle θ_{d} relative to vertical. Blade holder 100e is designed to hold a blade 102e at a 22.5-degree angle θₑ, relative to vertical, but in the opposite direction of blade 102d. Blade holder 100f is designed to hold a blade 102f horizontally, i.e., parallel to bottom surface 28.

Each of the blade holders 100a-100e is designed to be installed into blade opening 40. Each blade holder 100a-100e has a protrusion 104 extending downward, which is best seen in FIG. 2d. Protrusion 104 is designed to fit between edges 42a and 42b. A thickness of protrusion 104 is selected so that the bottom surface of the protrusion is coplanar with, or slightly recessed relative to, bottom surface 28 when installed in blade opening 40. Protrusion 104 helps by contacting the panel being cut around the blade while cuts are made. In some embodiments, opening 40 has one or more crossbars connected between edges 42a and 42b that can be used to align blades 100a-100e to one of the side surfaces of protrusion 104.

Each blade holder 100a-100e also includes a front flange 106 and back flange 108. Front flange 106 sits on front edge 42a when a blade holder is installed in cutting tool 10, while back flange 108 sits on back edge 42b within pocket 48. Front brace 50 slides back over flange 106 to create pocket 58 around the front flange and keep the blade holder in place within opening 40. Each of the flanges 106 and 108 optionally has a notch or recess 109 that can be used to align blade holders 100a-100e to optional bumps or pegs within pockets 48 and/or 58. In one embodiment, a single peg is installed in pocket 48 under back brace 44 and centrally located to allow a blade holder to easily be centered within cutting tool 10.

Each of the blade holders 100 is constructed of multiple pieces as illustrated in the exploded view of FIG. 2e. FIG. 2e illustrates blade holder 100b specifically, but the description applies generically to any of the blade holders 100. The pieces of different blade holders 100a-100f are the same functionally but shaped differently as illustrated in FIGS. 2a-2c to hold blades 102a-102f at their respective angles. The base of each blade holder 100 is formed from two separate sections, first body 110 and second body 112. Second body 112 is attached to first body 110 by screws 120 extending through openings 121a in the second body and screwed into threaded openings 121b of the first body. Screws 120 are countersunk into second body 112. Flanges 106 and 108 are split across bodies 110 and 112 as flanges 106a, 106b, 108a, and 108b.

Cammed lever 114 is attached to second body 112 by placing a bolt 124 through opening 125a of the second body, opening 115 of lever 114, and then screwing bolt 124 into threaded opening 125b. Lever 114 rotates freely about bolt 124 but includes a variable thickness around opening 115 so that the lever can be turned to tighten down between bolt 124 and blade 102, thereby holding the blade in place. FIG. 2f shows cammed lever 114a opened up to allow a blade 102a to be adjusted. Lever 114a is lifted away from second body 112a as illustrated by arrow 140. Arrow 142 illustrates adjustment of blade 102a within blade holder 100a. Rotating lever 114a around bolt 124 results in a thinner portion of the lever being located between the bolt and blade 102a, thus reducing the pressure applied by the cammed lever against the blade. Once blade 102a is adjusted to the desired position, cammed lever 114a is pressed back down toward second body 112a to move a thicker portion of the lever between bolt 124 and blade 102a, thus tightening the blade into place.

Returning to FIG. 2e, blade guide 116 is attached to first body 110 by two bolts 122 inserted through openings 123a and then screwed into threaded openings 123b. Blade guide 116 has a channel 130 to accommodate a blade 102 and allow the blade to slide up and down within the blade guide channel. First body 110 has a corresponding channel 132 that runs continuously from channel 130 of blade guide 116 when the blade guide is attached to the first body. A blade holder 100 with a blade 102 installed has the blade within channels 130 and 132, then tightened down with cammed lever 114. The sharp edge 103 of blade 102 is oriented toward the front of cutting tool 10 to cut a foam panel as the tool is pulled along using handle 14. Blades 102 are angled away from handle 14 as the blade gets further from a respective holder 100 so that the blades cut first at the surface of the panel being cut and then go deeper as cutting tool 10 is pulled.

FIG. 2g shows details of blade holder 100f. Blade holder 100f is designed to be installed onto recess 60 with thumbscrew 144 screwed into threaded hole 62. Mounting plate 146 has a width approximately equal to the width of the flat surface of recess 60, so the mounting plate can be aligned by feeling the sloped edges of the recess. Before tightening screw 144, mounting plate 146 can be moved up and down to adjust the distance between blade 102f and bottom surface 28. Slot 145 within mounting plate 146 allows the mounting plate to slide up and down around screw 144. Once screw 144 is tightened down around mounting plate 146, the vertical adjustment of blade 102f is fixed.

Blade holder 100f is also adjustable horizontally by sliding mounting plate 146 along dowels 148 as illustrated by arrow 149. Blade holder 100f includes a vertically oriented guide surface 150 that is adjusted closer or further away from the center of cutting tool 10 by the adjustment of mounting plate 146 along dowels 148. Once guide surface 150 is positioned as desired, the position is fixed by installing a bracket 151 into slot 152 of mounting plate 146. A bolt 154 is used to tighten down dowels 148 between bracket 151 and mounting plate 146, thus keeping the position of the mounting plate fixed on the dowels.

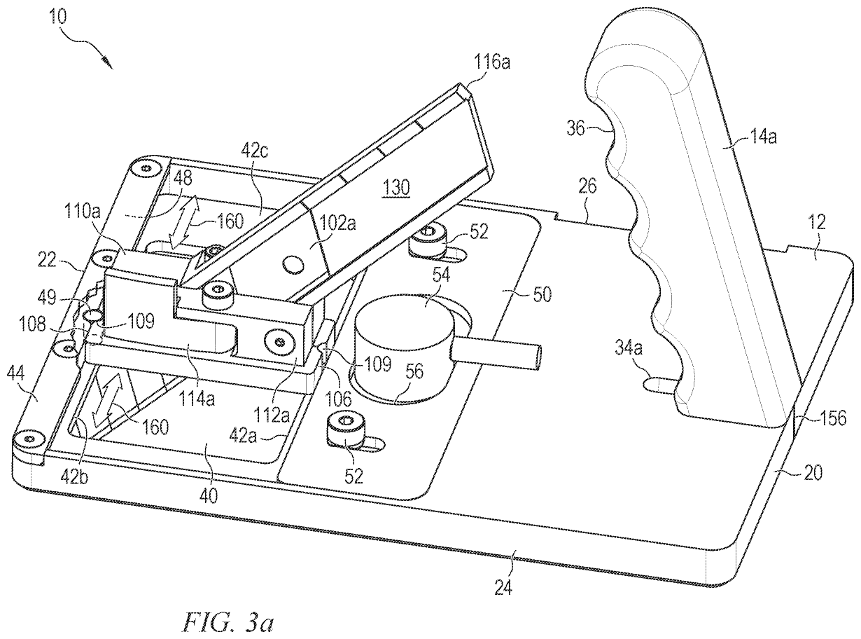

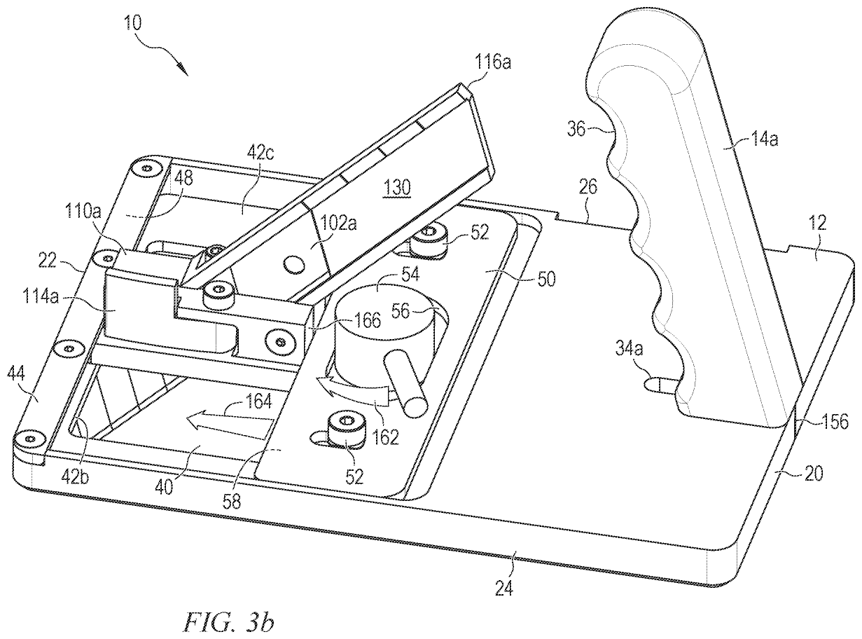

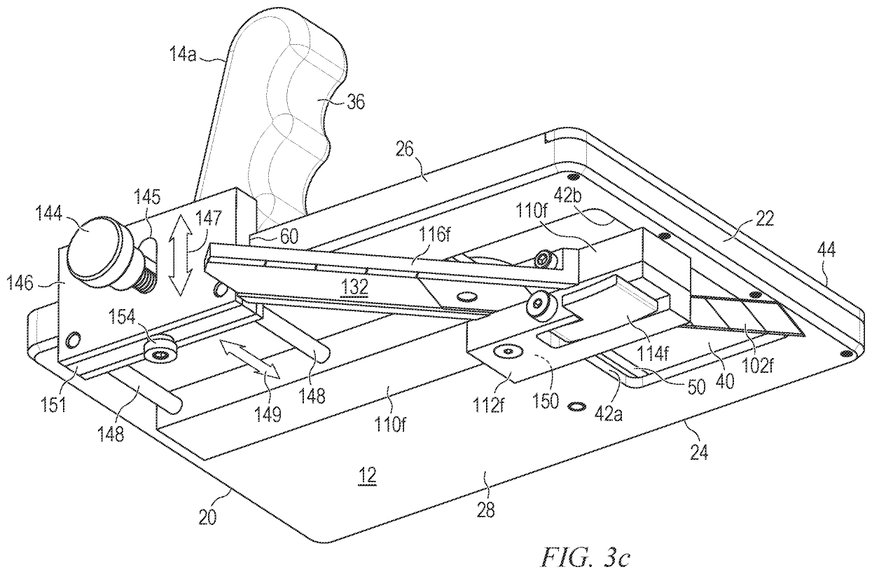

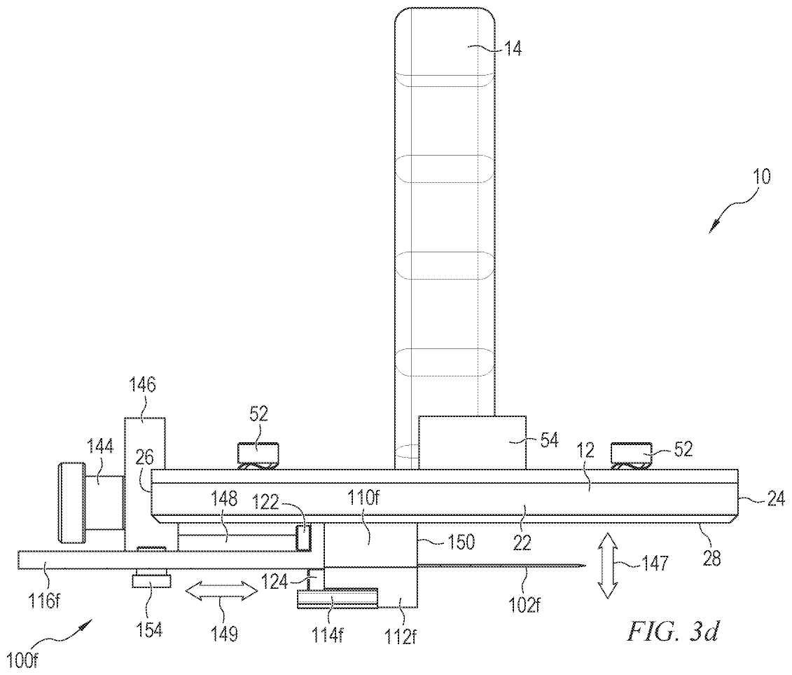

FIGS. 3a-3d illustrate installing blade holders 100a-100f onto cutting tool 10. In FIG. 3a, blade holder 100a is inserted into opening 40. Any blade holder 100a-100e can be installed in substantially the same way as illustrated for blade holder 100a. Blade holder 100a is placed with notch 109 of back flange 108 on dowel 49. Placing notch 109 on dowel 49 ensures that blade 102f will be aligned to handle 14 during cutting. Having blade 102a and handle 14 aligned helps cut a straight line because the blade drags directly behind the application of force on the handle. Moreover, a guide marker 156 is formed in base 12 under handle 14, so the user can easily follow where a blade 102 is cutting if the blade holder 100 is centered. Alternatively, blade holder 100a can be placed anywhere within opening 40, as indicated by arrows 160.

When initially installed, blade holder 100a is inserted into opening 40 with back flange 108 placed onto back edge 42b and front flange 106 placed onto front edge 42a. Blade holder 100a will be allowed to move around within opening sufficiently to adjust the lateral location of the blade holder and to move back flange 108 in and out of pocket 48.

Once blade holder 100a is situated as desired by the user, handle 54 is turned as shown by arrow 162 in FIG. 3b to move front brace 50 forward as illustrated by arrow 164. Front brace 50 presses against front surface 166 of blade holder 100a, pushing the blade holder forward and trapping front flange 108 within pocket 48. Front brace 50 being pressed back also creates pocket 58 to hold front flange 106 in place. The pressure and location of front brace 50 relative to blade holder 100a keeps the blade holder firmly held within blade opening 40 of cutting tool 10. Cutting tool 10 can be pulled along a block of foam to cut the foam using blade 102a. Blades 100a-100e can be removed, moved, or interchanged at any time by rotating handle 54 in the opposite direction of arrow 162, thereby moving front brace 50 forward and releasing any blade holders 100 installed in opening 40.

FIG. 3c illustrates installing blade holder 100f onto left edge 26. Mounting plate 146 is placed over recess 60 with screw 144 aligned to opening 62. Mounting plate 146 can be raised and lowered as indicated by arrow 147 to increase or decrease the distance between blade 102f and bottom surface 28. With screw 144 located where desired within slot 145, the screw is tightened down to hold mounting plate 146 in place on body 12 of cutting tool 10.

Guide surface 150 for blade 102f can be adjusted laterally by sliding the assembly including body 110f toward or away from mounting plate 146. Dowels 148 are fixed to body 110f and will slide through openings in mounting plate 146 as the adjustment occurs. Screw 154 is used to tighten down bracket 151 against dowels 148 and hold the blade 102f and body 110f assembly from further lateral movement. With both screws 144 and 154 tightened down, blade 102f is unable to move significantly. Blade 102f can be used to cut a foam block horizontally through an edge or side surface of the block.

FIG. 3d illustrates cutting tool 10 from the back with blade holder 100f installed. Blade 102f can be adjusted up, down, left, and right, as indicated by arrows 147 and 149, by temporarily loosening screws 144 and 154. The horizontal adjustment of arrow 149 is commonly used to align guide surface 150 relative to another blade holder 100a-100e installed in opening 40, allowing lateral alignment of a cut being made by a blade 102a-102e with a side surface of a foam block. The vertical adjustment of arrow 147 is typically used to center the cut of blade 102f within the side surface of a foam block.

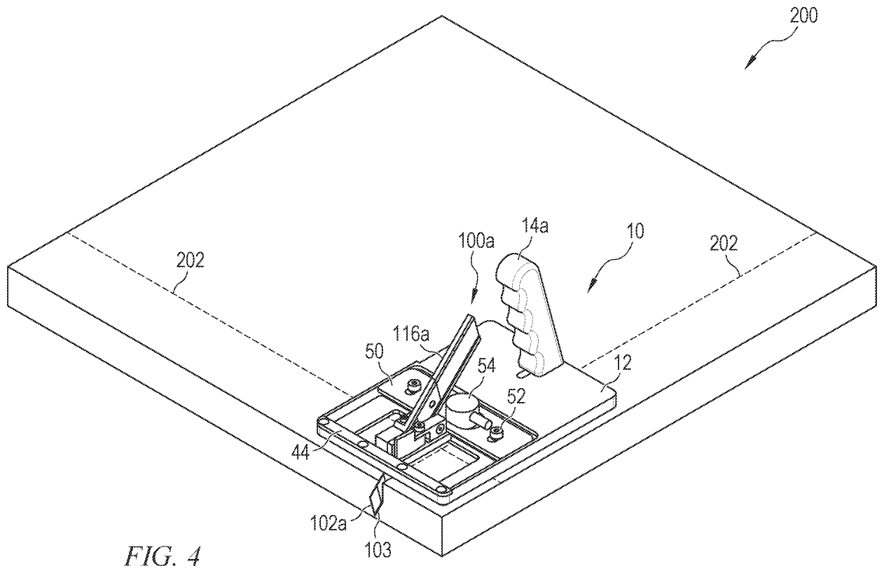

FIG. 4 illustrates a basic cut using cutting tool 10. A foam panel 200 is being cut down to a smaller size needed to form an HVAC duct or other structure. Foam panel 200 is comprised of, e.g., expanded polystyrene (EPS). Foam panel 200 can also be comprised of other materials, such as fiberglass and other non-foam materials. Blade holder 102a with 90-degree blade 102a is used to cut new perpendicular side surfaces of panel 200. Lines 202 indicate cuts that need to be made to reduce the size of foam panel 200 to the desired dimensions. Lines 202 can be drawn on by the end user as a guide after measuring the dimensions using a ruler or tape measure. If the user watches guide marker 156 while cutting and ensures that the guide marker stays aligned on top of drawn line 202, then the user will cut a substantially straight line directly on the intended cut location. In other embodiments, cutting tool 10 includes a laser attachment to shine a laser directly behind the tool and show the user the line being cut.

Before cutting, the length of blade 102a below bottom surface 28 of cutting tool 10 can be adjusted to ensure that blade 102a extends all the way through the thickness of panel 200 without extending significantly below the panel. Blade 102a is adjusted by lifting lever 114, sliding blade 102a to the desired position within blade holder 100a, and then pushing lever 114 back down to hold the blade in place. Blade 102a can be left longer than the thickness of foam panel 200 to ensure the cut extends completely through the panel as long as a proper cutting table or other underlying surface that won't be damaged by blade 102a is used. Blade 102a can be left short and not completely cut through the thickness of panel 200 to ensure that the underlying surface is not damaged, in which case the panel can be folded by hand to complete the cut after using cutting tool 10. Once both lines 202 are cut with cutting tool 10, the end user has a foam panel 200 of the size needed and can proceed with the intended use of the panel.

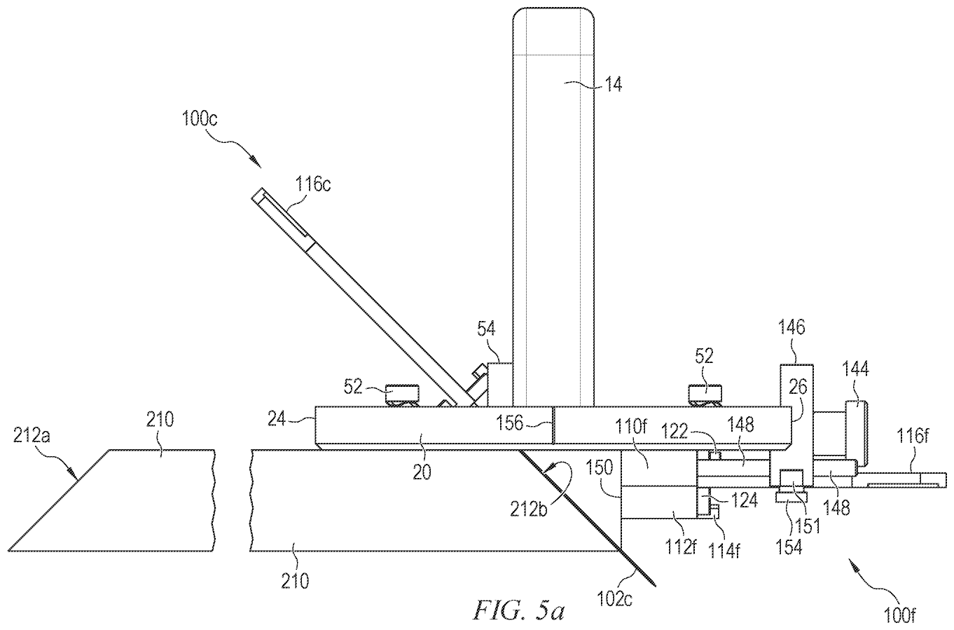

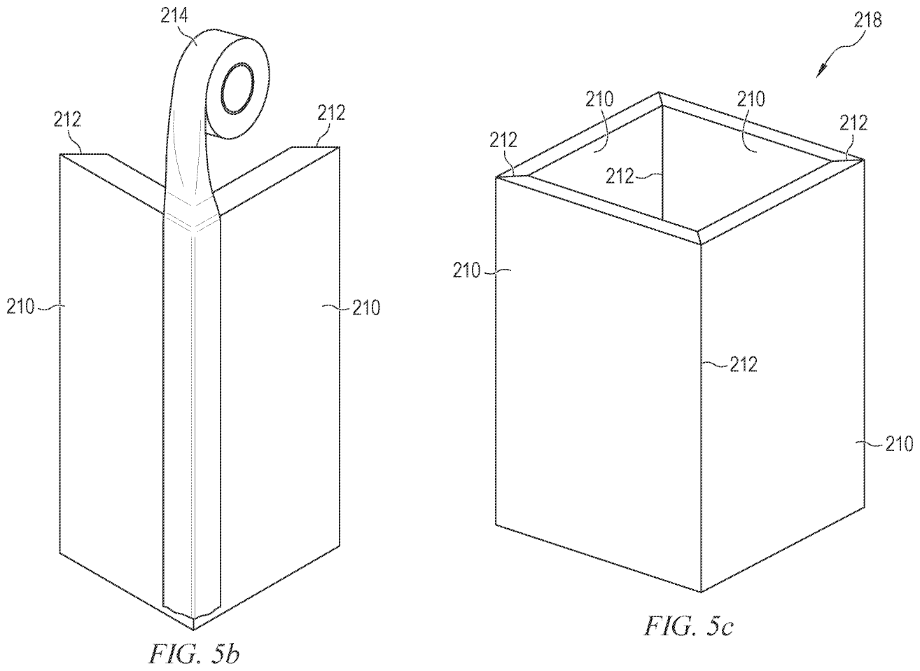

One of the uses for cutting tool 10 is to cut panels in order to construct HVAC ducting out of the panels. FIGS. 5a-5c illustrate forming a square duct by cutting panels 210 at angles. In FIG. 5a, blade holder 100c is being used to cut a 45-degree angled edge surfaces 212. Blade holder 100c holds blade 102c at a 45-degree angle relative to vertical, so cutting tool 10, with blade holder 100c and bottom surface 28 sitting on panel 210 as illustrated, will make 45-degree cuts 212 at the edge of the panel.

Cutting tool 10 is being pulled toward the viewer on the right edge of panel 210. The user could also use blade holder 100b to cut a 45-degree angle. The decision between blade holder 100c and 100b can be based on ergonomics; one side may be more comfortable than the other depending on the handedness of the user or other factors. Edges 212 are being cut with the 45-degree angle facing upward toward cutting tool 10, but the edges could also be formed facing downward away from the cutting tool.

Blade holder 100f is being used in FIG. 5a without blade 102f inserted into the blade holder, or at least not extending out of guide surface 150 toward panel 210. Without blade 102f, guide surface 150 can be used to align the cut of blade 102c relative to the original edge of panel 210 without making a horizontal cut into the panel. As panel 210 is being cut with blade 102c, guide surface 150 slides along the vertical side surface of panel 210 to keep cuts 212 a uniform distance from the original edge of the panel. Sliding mounting plate 146 along dowels 148 allows the location of blade 102c relative to the original vertical edge of panel 210 to be adjusted so that the end size of panel 210 after cutting can be fine-tuned.

Aligning cutting tool 10 using guide surface 150 of blade holder 100f results in a more reliably straight cut relative to alignment by eye only using guide marker 156. Blade holder 100f can be used to align a cut made with any blade holder 100 or combination of blade holders, although in some cases aligning with guide surface 150 won't make sense due to the need to make the cuts more internal to the panel being cut.

Once cuts 212 are made on two opposing sides of panels 210, two panels can be attached together at a 90-degree angle as shown in FIG. 5b. Panels 210 can be attached together by tape 214, adhesive, fasteners, or another suitable means. Four panels 210 are attached together to form a square duct 218 as shown in FIG. 5c. Multiple ducts 218 can be formed and taped together to form extended-length ducts. One of the panels 210 can be formed shorter, and then combined with a duct having one of the panels longer, to create a duct with a 90-degree turn. Duct 218 as a whole can have its end cut with an angle to create turns of lesser than 90 degrees. While the ends of panels 210 remain flat, the ends can also have 45-degree angles to interface with adjacent duct sections that also have 45-degree cuts. A shiplap cut is illustrated below that can also be used on the ends of ducts 218.

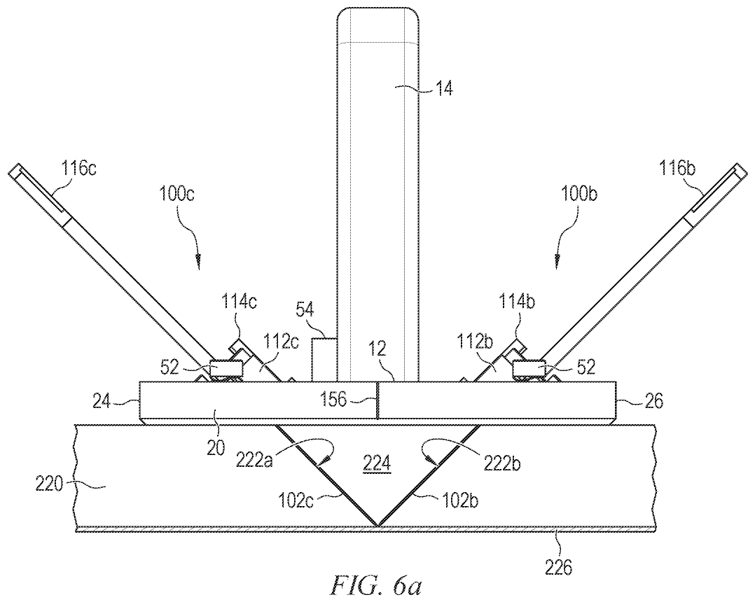

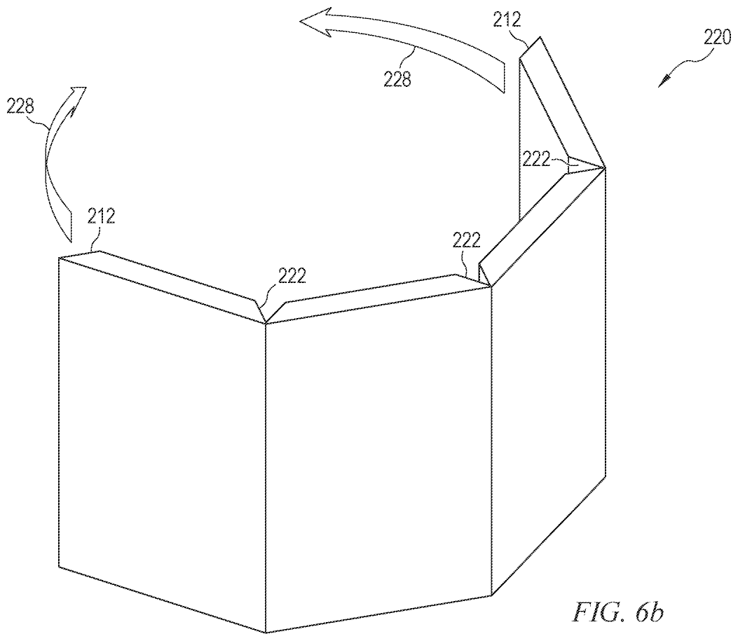

Rather than tape together multiple separate panels to form a duct, some panels are capable of holding themselves together if a cut is formed only partially through the panel as shown in FIG. 6a. Panel 220a is being cut using blade holders 100b and 100c in combination to cut a 90-degree angle in one pull of cutting tool 10. Blade holders 100b and 100c are positioned symmetrically within opening 40 at a distance apart from each other as determined by the separation needed to get cuts 222 to the desired length. Blades 102b and 102c are adjusted to where the blades contact each other or nearly contact each other, so that the two cuts 222a and 222b are continuous with each other and a portion 224 of panel 220 is removed after completing the cut. Cuts 222 leave panel 220 as a single piece, rather than cutting completely through the panel to create two separate panels.

In some embodiments, panel 220 has a liner 226 that physically supports panel 220 with cuts 222. Liner 226 is a foil, plastic, cloth, or other material attached to panel 220 during manufacture using an adhesive. Cuts 220 can be sized to extend completely through panel 220 but leave liner 226 intact. Liner 226 is flexible so that panel 220 with cuts 222 can be folded up so that the cut surfaces physically contact each other. Liner 226 keeps the two sides of panel 220 attached but allows the panel to flex across the cut. In other embodiments, cuts 222 extend completely through panel 220, and the separate pieces are attached to each other to form a duct as shown in FIGS. 5b and 5c.

In FIG. 6b, panel 220 has three internal 90-degree cuts 222, as well as two 45-degree edges 212 on the ends of the panel as previously formed in FIG. 5a. Panel 220 remains as a single panel due to 90-degree cuts 222 being formed only partially through the panel or being held together by liner 226. Panel 220 is folded into a square as illustrated by arrows 228 until outside edges 212 meet. The result of folding edges 212 together is a square duct similar to duct 218 in FIG. 5c. Each set of opposing cuts 222 physically contact each other as well. A bead of adhesive can be deposited onto cuts 222 prior to folding up panel 220 to help the resulting duct hold its form. Edges 212 are fastened to each other using tape, adhesive, fasteners, or another suitable means. Tape 214 can also be added onto the outside of the corners with cuts 222 for added strength if desired.

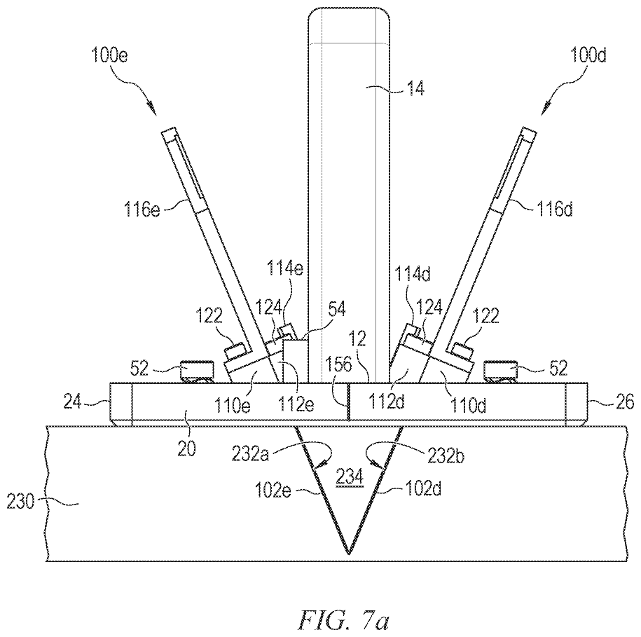

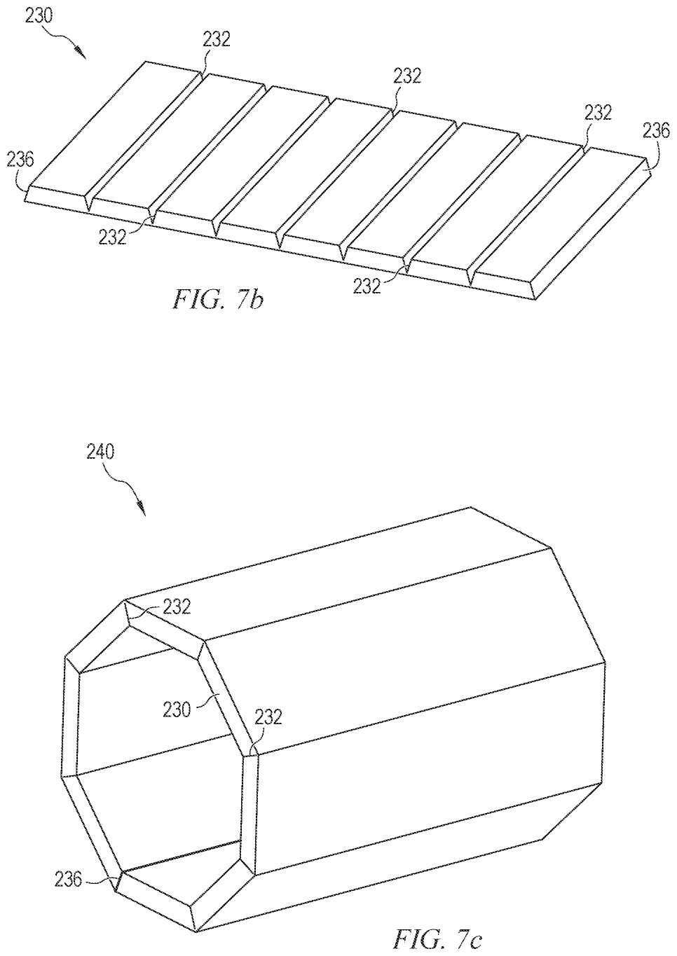

FIGS. 7a-7c show a similar concept with the 22.5-degree blade holders 100d and 100e used in tandem to cut a angle into panel 230. Blade holders 100d and 100e are again positioned so that the distance between them is appropriate for the desired length of cuts 232. Blades 102d and 102e are adjusted downward until the two cuts 232 meet so that portion 234 of panel 230 can be removed after the cuts 232 are complete. Whereas panel 220 in FIG. 6a had a liner 226 to keep the portions of the panel attached to each other, panel 230 has no liner and is kept together by the bulk panel material. A lack of liner may increase the need for a separate adhesive or tape to keep each joint connected in the final duct. In another embodiment, cuts 232 completely separate panel 230 into multiple pieces, which are subsequently attached together to form a duct.

FIG. 7b illustrates panel 230 with seven pairs of cuts 232 formed in parallel to split the panel into eight sub-panels. Two individual 22.5-degree cuts 236 are formed on the ends of panel 230 as shown in FIG. 5a but using a 22.5-degree blade. Panel 230 is folded similar to the folding shown in FIG. 6b to form an octagonal duct 240 in FIG. 7c. Each of the cuts 232 and 236 can be taped or glued as needed to keep the shape of duct 240. A plurality of panels 230 can be connected before cutting and folding, or a plurality of ducts 240 can be attached together, to form a longer duct. Ends of duct 240 can be cut as needed to route the ducting, e.g., between an air handler and an air vent. Using the 22.5-degree blades creates a duct 240 with a wider radius compared to the square duct 218. A duct can be formed with any suitable number of sides by creating blade holders 100 with the needed angle being 360-degrees divided by the number of sides, and then divided by two to get the final blade angle for a blade holder.

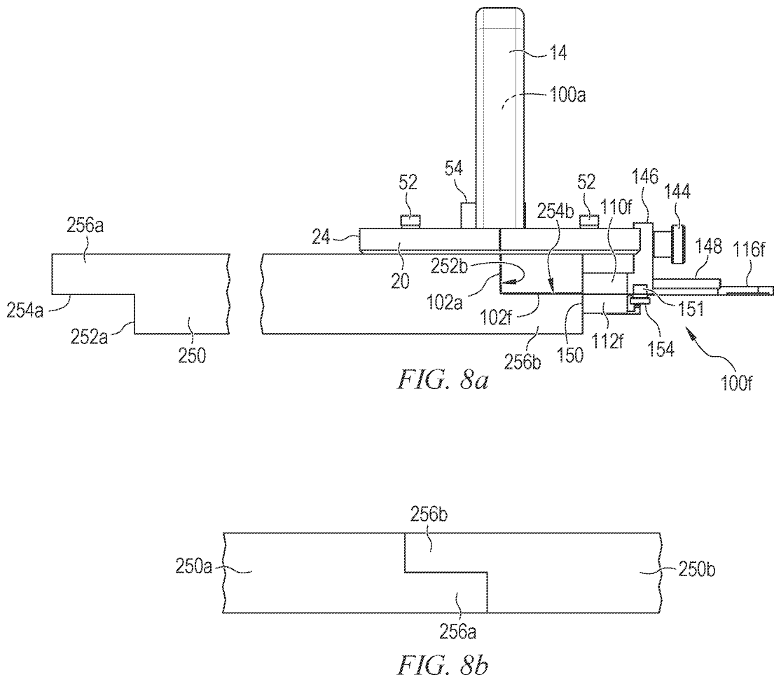

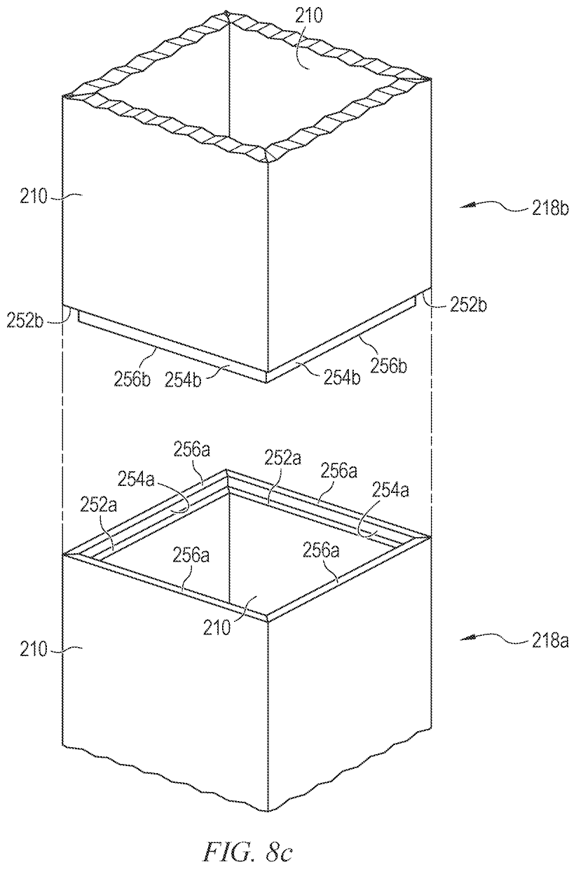

FIGS. 8a-8c illustrate utilizing blade holders 100a and 100f in combination to perform a shiplap cut. Panel 250 has a vertical cut 252a and a horizontal cut 254a that have already been cut on the left side of FIG. 8a to create a half-thickness edge 256a of the panel. Cuts 252b and 254b are actively being made in FIG. 8a by pulling blades 102a and 102f through panel 250 using cutting tool 10 with blade holders 100a and 100f. Guide surface 150 keeps cut 252b parallel with the side surface of panel 250. Blade holder 100f is adjusted vertically to make blade 102f cut approximately in the middle of the panel. The width of edge 256a can be adjusted by horizontal adjustment of blade holder 100f defining the horizontal position of vertical blade 102a. The extension lengths of blades 102a and 102f are adjusted so that the ends of the blades meet at a 90-degree angle.

After cuts 252 and 254 are completed for at least two panels, the panels can be combined to form a larger size panel as shown in FIG. 8b. Panels 250a and 250b are attached together with half-height edges 256a and 256b overlapping each other. Making cuts 254 halfway through each panel 250 results in top and bottom surfaces of the panels that are coplanar when attached together. Tape or adhesive is used to hold the panels together. Any number and size of panels 250 can be combined to result in a combined panel of any desired size.

In addition to attaching flat panels with shiplap cuts, the shiplap cuts can be used to combine 3D structures together, such as completed duct sections as shown in FIG. 8c. In FIG. 8c, each panel 210 of two square duct 218a and 218b has cuts 252 and 254 formed on the open ends of the ducts. The ducts 218 are put together so that one open end of each duct has half-thickness edge 256a oriented toward the interior of the duct, and the other open end of the duct has half-thickness edge 256b oriented toward the exterior of the duct. That way, duct 218a and 218b can be interfaced with edges 256 overlapping. The result is that two ducts can be combined into a longer duct with overlapping between the ducts improving airtightness. Adhesive or tape is used to attach ducts 218a and 218b together.

Cutting tool 10 has a wide variety of uses in cutting foam or other material panels. Utilizing a cutting tool with interchangeable blade holders having a variety of cutting angles reduces the overall size and weight of the tool, thus making the tool much easier to store, carry, and use. Having blade holders with easily adjustable blades increases safety of the tool. The use of cutting tool 10 is not limited to only foam or only for HVAC ducting uses. Cutting tool 10 can be used for cutting a variety of materials for a variety of uses.

While one or more embodiments of the present invention have been illustrated in detail, the skilled artisan will appreciate that modifications and adaptations to those embodiments may be made without departing from the scope of the present invention as set forth in the following claims.

What is claimed:

1. A cutting tool, comprising:
a base;
a blade opening formed through the base, wherein the blade opening includes a front edge and a back edge oriented parallel to the front edge; and
a plurality of interchangeable blade holders configured to be installed into the blade opening, wherein each of the interchangeable blade holders includes a front flange configured to sit on the front edge of the blade opening and a back flange configured to sit on the back edge of the blade opening.

2. The cutting tool of claim 1, further including a bump disposed in the blade opening, wherein each of the interchangeable blade holders includes a recess configured to interface with the bump.

3. The cutting tool of claim 1, wherein each of the interchangeable blade holders includes a caromed lever that allows a blade to be adjusted when the caromed lever is raised.

4. The cutting tool of claim 1, further including a horizontal blade holder configured to attach to an outside edge of the base.

5. The cutting tool of claim 4, wherein the horizontal blade holder is installed onto the outer edge of the base without a blade installed in the horizontal blade holder.

6. The cutting tool of claim 1, further including a sliding plate configured to extend over the front flange of an interchangeable blade holder to hold the interchangeable blade holder in the blade opening.

7. The cutting tool of claim 1, further including a first blade holder and second blade holder from the plurality of interchangeable blade holders installed in the blade opening.

8. A cutting tool, comprising:
a base;
a blade opening formed through the base; and
a plurality of interchangeable blade holders configured to be installed into the blade opening.

9. The cutting tool of claim 8, wherein the base includes a brace configured to slide over a portion of a blade holder disposed in the blade opening.

10. The cutting tool of claim 9, further including a caromed handle disposed in an opening of the brace.

11. The cutting tool of claim 8, further including a horizontal blade holder configured to be attached to an outer edge of the base.

12. The cutting tool of claim 11, wherein the horizontal blade holder includes a horizontal adjustment and a vertical adjustment.

13. The cutting tool of claim 8, wherein each of the plurality of interchangeable blade holders is configured to hold a blade at a different angle relative to the base.

14. The cutting tool of claim 8, wherein the blade opening includes a front lip and back lip oriented parallel to each other.

15. A method of making an HVAC duct, comprising:
providing a cutting tool including a plurality of interchangeable blade holders;
installing a first blade holder into the cutting tool;
cutting a first panel and a second panel with the cutting tool and first blade holder; and
attaching the first panel to the second panel.

16. The method of claim 15, further including installing a second blade holder into the cutting tool along with the first blade holder.

17. The method of claim 16, further including cutting a third panel with a first blade of the first blade holder and a second blade of the second blade holder at the same time.

18. The method of claim 16, wherein a first angle of the first blade holder and a second angle of the second blade holder are symmetrical.

19. The method of claim 16, wherein the second blade holder is configured to hold a blade horizontally.

20. The method of claim 19, wherein the first blade holder is configured to hold a first blade vertically.
